(19) United States
(12) Patent Application Publication
(10) Pub. No.: US 2011/0313749 A1
(43) Pub. Date: Dec. 22, 2011

(54) CIRCUIT CONSTANT ANALYSIS METHOD AND CIRCUIT SIMULATION METHOD OF EQUIVALENT CIRCUIT MODEL OF MULTILAYER CHIP INDUCTOR

(75) Inventor: Xiangying Wu, Gunma (JP)

(73) Assignee: TAIYO YUDEN CO., LTD., Tokyo (JP)

(21) Appl. No.: 13/203,689

(22) PCT Filed: Feb. 24, 2010
(86) PCT No.: PCT/JP2010/053474

§ 371 Date: Aug. 26, 2011

(30) Foreign Application Priority Data
Mar. 2, 2009 (JP) 2009-048674

(51) Int. Cl. G06F 17/50

(52) U.S. Cl. 703/14; 703/13

(57) ABSTRACT

The occurrence of errors between circuit design using a circuit simulator and the actual circuit performance is quite adequately suppressed. Mutual inductance (Lm) between direct current inductance (L0) and inductance (L1) is connected in parallel to a series circuit of the inductance (L1) and resistance (R1), the series circuit taking the skin effect of an inner conductor into consideration and the inductance (L0), and direct current resistance (Rdc1) of the inner conductor are connected in series to the series circuit to which the mutual inductance (Lm) is connected in parallel. Then, parasitic inductance (Ls) of an external electrode is connected in series to the equivalent inductance (L0), and direct current resistance (Rdc2) of the external electrode is connected in series to the direct current resistance (Rdc1) of the inner conductor. In addition, a series circuit in which parasitic capacitance (Cp) and resistance (Rp) representing the loss of a dielectric constituting a chip are connected in series is connected to the inner sides of the equivalent elements (Ls, Rdc2) of the external electrode. Thus, the constituted equivalent circuit is used.

### TECHNICAL FIELD

The present invention relates to a method for analyzing circuit constants of an equivalent circuit model and to a method of circuit simulation, of a multilayer chip inductor, and more particularly, to an improvement of the method for analyzing circuit constants of the equivalent circuit model, and to an improvement of the method of circuit simulation, of the multilayer chip inductor suitable for characteristics simulation of a circuit including the multilayer chip inductor that has a rectangular cuboid-shaped dielectric chip for high frequency use, internal conductors embedded in the chip and having terminals each led out to a surface of the chip, and external electrodes formed on the surface of the chip electrically connecting to the terminals of the internal conductor.

### BACKGROUND ART

The following Patent Documents 1 to 4 disclose the background art related to characteristics simulation of a circuit including an inductor, for example. In Patent Document 1, a highly accurate equivalent circuit capable of expressing characteristics of an inductance element accurately using a ferrite material and its analysis method and the like are disclosed. In Patent Document 2, an equivalent circuit expressing an inductance element formed on a semiconductor substrate with small frequency dependence and its simulation method are disclosed. In Patent Document 3, an evaluation method of a planar type inductance element formed on an upper surface of a dielectric substrate is disclosed. In Patent Document 4, an equivalent circuit expressing a motor coil and a circuit simulator are disclosed.

As shown in FIG. 6(A), a basic equivalent circuit of an inductor is a circuit in which a parasitic capacitance Cp is connected in parallel to a series circuit in which an inductance L is connected in series to a resistance R expressing a loss including the skin effect of a conductor. Every one of the elements is dependent on frequency. When a circuit analysis by a circuit simulator such as SPICE or the like using such an equivalent circuit is performed, significant errors occur due to the existence of frequency characteristics of each element, and an actual performance of the circuit designed is far outside of the target performance value of the designed circuit.

In order to improve such a problem, there is a circuit modeling method, as described in the following Non-Patent Document 1. That is, a fractional polynomial is separated at the second order when performing the modeling of a circuit element, and combined by connecting a serial resonance circuit in parallel and connecting a parallel resonance circuit in series. However, in order to achieve high accuracy by such a method of combining circuits of a general fractional polynomial, the order of the polynomial needs to be increased and the circuit configuration becomes considerably complicated.

In contrast, in Non-Patent Document 2, a ladder circuit, which takes into consideration the skin effect of a metal and the electromagnetic proximity effect, is disclosed. FIG. 6(B) discloses its circuit configuration. A direct current inductance L0 is connected to a direct current resistance Rdc of the conductor in series, and a series connection circuit of an inductance L1 and a resistance R1, which takes into consideration the skin effect of a metal, is connected in parallel to the direct current resistance Rdc of the conductor in a circuit. This is for the purpose of capturing frequency characteristics of the equivalent inductance L and the resistance R of the conductor, which depend on frequency, in the basic equivalent circuit. Also, in order to take into consideration the electromagnetic proximity effect, a mutual inductance Lm is added between the inductances L0 and L1. Each circuit element does not depend on frequency.

However, the characteristics obtained by using the equivalent circuits of the background art, as described above, do not accurately reflect actual characteristics of a multilayer chip inductor. Thus, an accurate prediction of the characteristics in a desired frequency range is difficult when circuit design or the like is done using a circuit simulator. Particularly, effects of each parasitic component become large toward a high frequency side, and the characteristic of the multilayer chip inductance becomes complicated and cannot accurately be expressed.
Patent Document 1: Japanese Patent Application Laid-Open Publication No. H11-312187
Patent Document 2: Japanese Patent Application Laid-Open Publication No. 2004-235279
Patent Document 3: Japanese Patent Application Laid-Open Publication No. 2000-28662
Patent Document 4: Japanese Patent Application Laid-Open Publication No. 2007-122574
Non-Patent Document 1: Michitaka Kouno, Toshiji Kato, Kaoru Inoue “Parameter Extraction Methods for a Lumped Circuit Model,” The SCIENCE and ENGINEERING REVIEW of DOSHISHA UNIVERSITY, Vol. 45, No. 2 pp. 1-14, July 2004.
Non-Patent Document 2: Yu Cao; Groves, R. A.; Xuejue Huang; Zamdmer, N. D.; Plouchart, J.-O.; Wachnik, R. A.; Tsu-Jae King; Chenming Hu, “Frequency-independent equivalent-circuit model for on-chip spiral inductors”, IEEE Journal of Solid-State Circuits, Volume 38, Issue 3, March 2003 Page(s): 419-426.

### SUMMARY OF THE INVENTION

### Problems to be Solved by the Invention

The present invention has focused on the above aspects, and an object is to provide a circuit constant analysis method and a circuit simulation method for an equivalent circuit model of a multilayer chip inductor that are capable of suppressing occurrence of errors between a target performance in a circuit design using a circuit simulator and an actual circuit performance, when frequency fluctuates.

### Means for Solving the Problems

In order to achieve the above-described object, a method of analyzing circuit constants of an equivalent circuit model of a multilayer chip inductor in the present invention is a method in which the multilayer chip inductor includes a rectangular cuboid-shaped dielectric chip, internal conductors embedded within the chip having terminals each being led out to a surface of the chip, and external electrodes formed on the surface of the chip so as to electrically connect to the terminals of the internal conductors, wherein the equivalent circuit model has a first parallel circuit in which a mutual inductance Lm between an inductance L0 with respect to a direct current and an inductance L1 for the electromagnetic proximity effect consideration is connected in parallel to a first series circuit in which the inductance L1 is connected in series to a resistance R1 for the skin effect consideration of the internal conductor, a second series circuit in which the inductance L0 is connected in series to one end of the first parallel circuit, and a direct current resistance Rdc1 of the internal conductor is connected in series to the other end of the first parallel circuit, a second parallel circuit, which includes a third series circuit in which a parasitic capacitance Cp is connected in series to a resistance Rp indicating a loss of the dielectric constituting the chip, is connected in parallel to the second series circuit, a parasitic inductance Ls of the external electrode connected in series to one end of the second parallel circuit, and a direct current resistance Rdc2 of the external electrode connected in series to the other end of the second parallel circuit, the method includes determining numerical values of the circuit constants included in the equivalent circuit model so that a typical value of relative error between the impedance value of the equivalent circuit model of the multilayer chip inductor and an actual measured value of the impedance of the multilayer chip inductor is minimized.

In one of preferred embodiments, a fourth series circuit in which an inductance L2 is connected in series to a resistance R2 for consideration of the thickness of the internal conductor is further connected in parallel to the first parallel circuit of the equivalent circuit model.

Also, in another embodiment, the numerical values of the circuit constants of the equivalent circuit are determined so that the typical value of the relative error is less than or equal to 10%.

In a method of circuit simulation for performing a characteristics simulation of a circuit including a multilayer chip inductor, the method of circuit simulation in the present invention includes performing the characteristics simulation of the circuit including the multilayer chip inductor using the equivalent circuit model of the multilayer chip inductor in which the circuit constants are determined by the above described method of analyzing circuit constants.

### Effects of the Invention

In accordance with the present invention, by extracting equivalent circuit constants based on an equivalent circuit model, which takes into consideration a dielectric loss, an inductance and a resistance of an external electrode, the skin effect and the electromagnetic proximity effect of an internal conductor, and a thickness of the internal conductor, occurrence of errors between performance of a circuit design using a circuit simulator and performance of an actual circuit can be effectively suppressed. The above described object, and other objects, characteristics, and advantages of the present invention are clarified by the following detailed descriptions and attached drawings.

### BRIEF DESCRIPTION OF THE DRAWINGS

FIG. 1 shows circuit diagrams showing equivalent circuits of Embodiment 1 according to the present invention.

FIG. 2 shows circuit diagrams showing equivalent circuits of Embodiment 2 according to the present invention.

FIG. 3 is a flow chart showing an example of a method for specifically determining the circuit constants in the equivalent circuits.

FIG. 4 shows graphs showing characteristics based on the equivalent circuits of the Embodiments by comparing with the background art and the actual measured values.

FIG. 5 is block diagram showing an example of a simulation apparatus in which the present invention is applied.

FIG. 6 shows circuit diagrams showing examples of conventional equivalent circuits.

### DETAILED DESCRIPTION OF EMBODIMENTS

Preferred embodiments of the present invention are described in detail below with references to examples of the embodiments.

### Embodiment 1

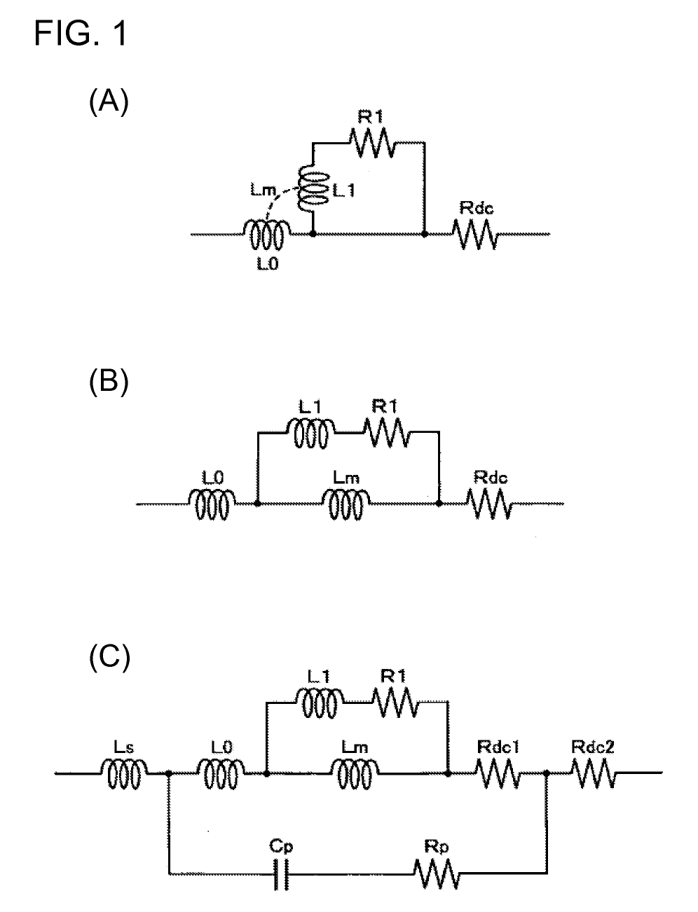

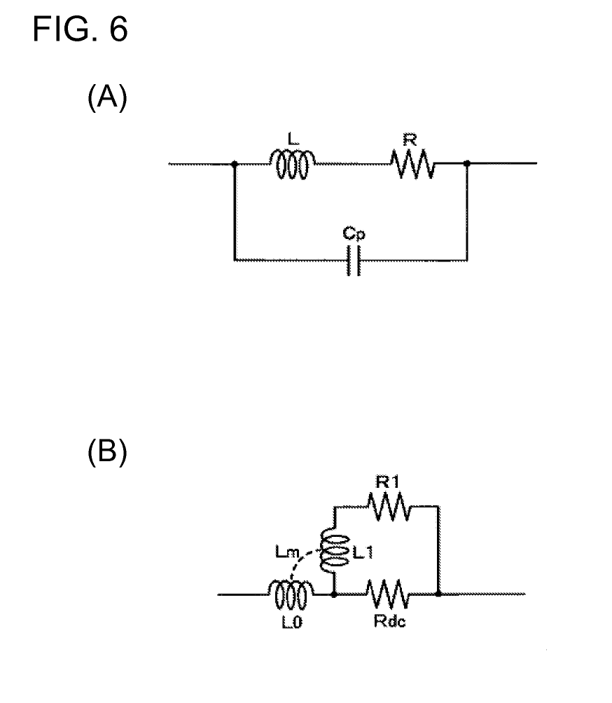

First, in order to facilitate understanding of the present invention, how an equivalent circuit of the present invention is brought about from the ladder circuit described above is described with reference to FIG. 1. As shown in FIG. 6(B), in the ladder circuit of Cao et al., the direct current resistance is not the direct current resistance Rdc of the conductor originally defined, rather it is a parallel circuit of Rdc and R1. Thus, as shown in FIG. 1(A), in the present invention, a series circuit of an inductance L1 and a resistance R1 for taking the skin effect of the conductor into consideration is shorted with respect to direct current, and then connected in series to an inductance L0 with respective to the direct current and to a direct current resistance Rdc of the conductor.

Next, if a mutual inductance Lm between the inductances L0 and L1, which is included in the improved ladder circuit of FIG. 1(A), is expressed in a decoupling form, then it becomes the circuit as shown in FIG. 1(B). That is, the mutual inductance Lm is connected in parallel to the series circuit of R1, L1, and the inductance L0 with respect to the direct current and the direct current resistance Rdc of the conductor are connected in series to this parallel circuit.

Next, an equivalent circuit of the present embodiment as shown in FIG. 1(C) is obtained by taking into consideration the dielectric loss, and the inductance and resistances of an external electrode all at the same time. That is, the inductance Ls of the external electrode is connected in series to the inductance L0, and a direct current resistance Rdc2 of the external electrode is connected in series to a direct current resistance Rdc1 of the internal conductor. Also, a series circuit in which a parasitic capacitance Cp of the dielectric that constitutes a chip of the multilayer chip inductor is connected in series to a resistance Rp representing the loss in the dielectric is connected in parallel to the inner sides of the equivalent elements Ls, Rdc2 of the external electrodes.

Next, the case that a simulation is performed using the equivalent circuit (SPICE model) of the multilayer chip inductor in the present embodiment above is described.

For instance, when a SPICE simulator is used as a simulator, a SPICE file of the equivalent circuit of FIG. 1(C) is as follows, for example.

.subckt HK1 1 2
Ls 1 3 Lval1
L0 3 4 Lval2
Lm 4 5 Lval3
L1 4 7 Lval4
R1 7 5 Rval1
Cp 3 8 Cval1
Rp 8 6 Rval2
Rdc1 5 6 Rval3
Rdc2 6 2 Rval4
.ends

Here, component names and copyright notices are added as comments whenever necessary. Also, specific numerical values of circuit constants are written to Lval1, Lval2, . . . in the above file. For example, when a value of Ls is 0.58 nH, it is written as
Ls 1 3 0.58 n
   Specific examples are described later.

Next, a program file of a SPICE model written in FORTRAN is as follows. The SPICE file described above can be read by a SPICE simulator as it is. However, the program file below needs to be compiled. In this case also, component names and copyright notices are added whenever necessary.

Complex Function ZHK1(Ls, L0, Lm, L1, R1, Cp, Rp, Rdc1, Rdc2, Freq)
Complex AIM, ZLs, ZL0, ZLm, ZL1, ZCp, Z1, Z2, Z3
data PI/3.1415926/,AIM/(0.0,1.0)
ZLs=AIM*2.0*PI*Freq*Ls
ZL0=AIM*2.0*PI*Freq*L0
ZLm=AIM*2.0*PI*Freq*Lm
ZL1=AIM*2.0*PI*Freq*L1
ZCp=1./(AIM*2.0*PI*Freq*Cp)
Z1=R1+ZL1
Z2=ZL0+1./(1./ZLm+1./Z1)+Rdc1
Z3=1./(1./Z2+1./(ZCp+Rp))
ZHK1=ZLs+Z3+Rdc2
Return
End

### Embodiment 2

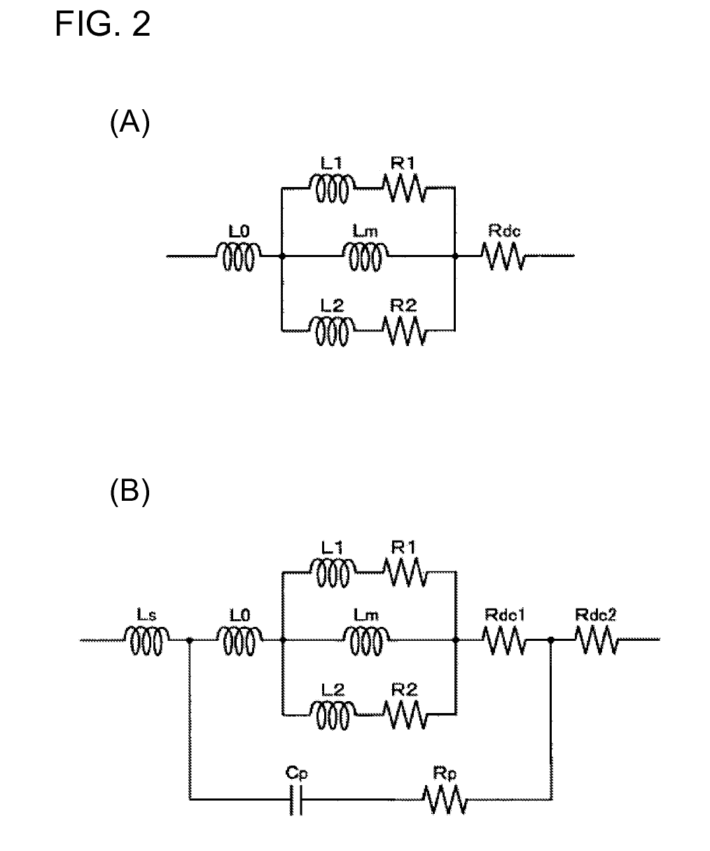

Next, Embodiment 2 of the present invention is described with reference to FIG. 2. In the ladder circuit in the decoupling form shown in FIG. 1(B), if the thickness of a metal layer constituting the internal conductor of the multilayer chip inductor is taken into consideration, it becomes an equivalent circuit shown in FIG. 2(A). That is, the skin effect of side surfaces of the metal layer is expressed as a series circuit of an inductance L2 and a resistance R2, and this is connected in parallel to the series circuit of the inductance L1 and the resistance R1, which takes into consideration the skin effect of both upper and lower main surfaces of the metal layer, and to the inductance Lm expressed in the decoupling form.

Next, in a manner similar to the previous Embodiment, an equivalent circuit of the present embodiment shown in FIG. 2(B) is obtained by taking into consideration the dielectric loss and a parasitic inductance and resistance of the external electrode at the same time. That is, a parasitic inductance Ls of the external electrode is connected in series to the inductance L0, and a direct current resistance Rdc2 of the external electrode is connected in series to the direct current resistance Rdc1 of the internal conductor. Also, a series circuit in which a parasitic capacitance Cp of the dielectric that constitutes the chip is connected in series to a resistance Rp representing the loss in the dielectric material is connected in parallel to the inner sides of the equivalent elements Ls, Rdc2 of the external electrodes.

SPICE file of the above described equivalent circuit shown in FIG. 2(B) is as follows, for example.

.subckt HK2 1 2
Ls 1 3 Lval1
L0 3 4 Lval2
Lm 4 5 Lval3
L1 4 7 Lval4
R1 7 5 RVal1
L2 4 8 Lval5
R2 8 5 Rval2
Cp 3 9 Cval1
Rp 9 6 Rval3
Rdc1 5 6 Rval4
Rdc2 6 2 Rval5
.ends

Also, a program file of the SPICE model in FORTRAN is as follows.

| Complex Function ZHK2(Ls, L0, Lm, L1, R1, L2, R2, | |
|---|---|
| 1 | Cp, Rp, Rdc1, Rdc2, Freq) |

Complex AIM, ZLs, ZL0, ZLm, ZL1, Zl2, ZCp, Z1, Z2, Z3
data PI/3.1415926/,AIM/(0.0,1.0)
ZLs=AlM*2.0*PI*Freq*Ls
ZL0=AIM*2.0*PI*Freq*L0
ZLm=AIM*2.0*PI*Freq*Lm
ZL1=AIM*2.0*PI*Freq*L1
ZL2=AIM*2.0*PI*Freq*L2
ZCp=1./(AIM*2.0*PI*Freq*Cp)
Z1=1./(1./ZLm+1./(R1+ZL1)+1./(R2LZL2))
Z2=ZL0+Z1+Rdc1
Z3=1./(1./Z2+1./(ZCp+Rp))
ZHK2=ZLs+Z3+Rdc2
Return
End

### Specific Example

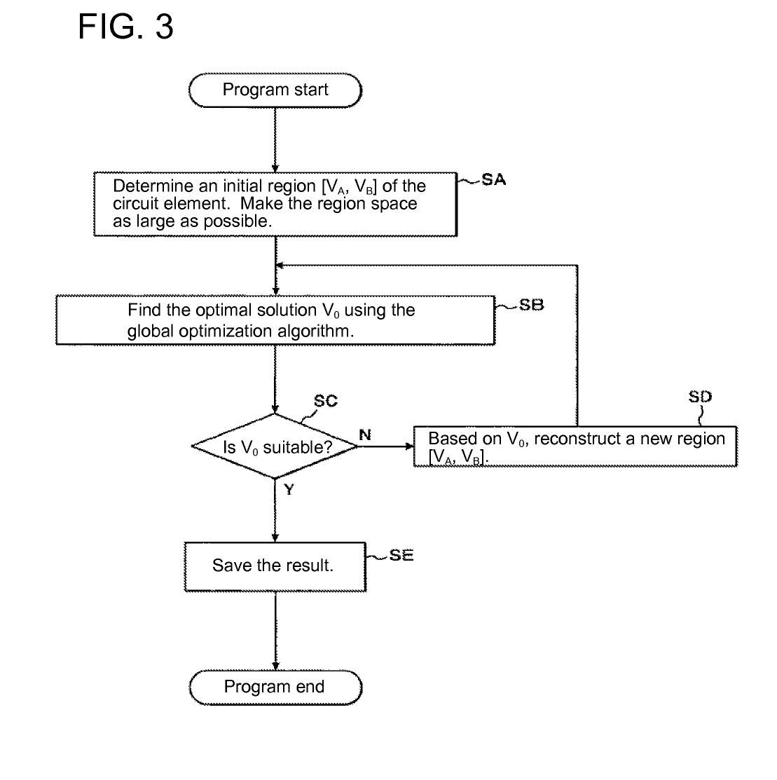

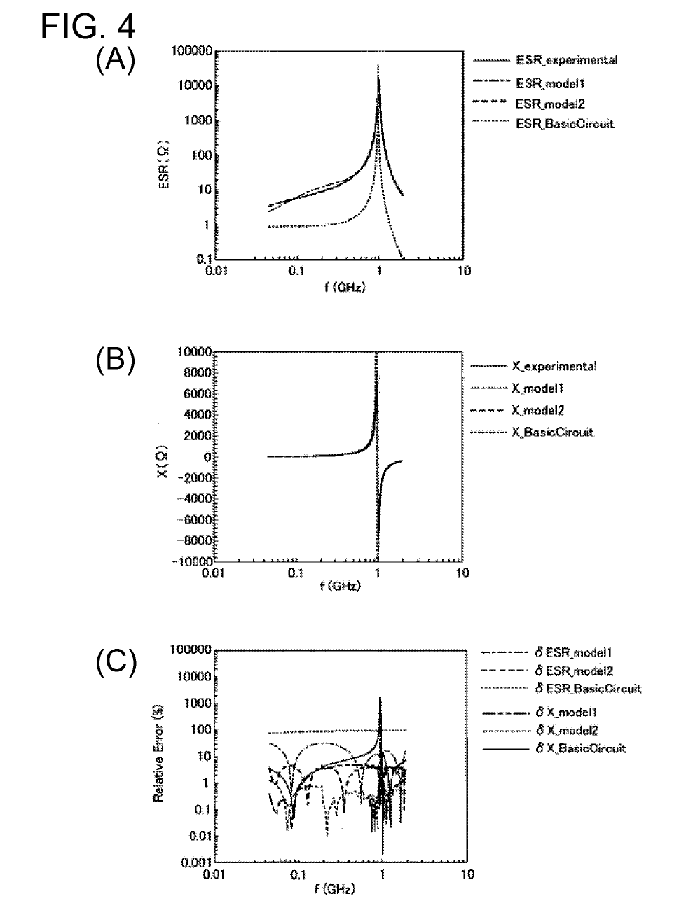

Next, referring to FIG. 3 to FIG. 4, examples of specific numerical values of the Embodiments and simulation examples of the Embodiments are described below. In order to perform a simulation using the equivalent circuit model of the Embodiments as described above, it is necessary to specifically determine circuit constants included in each of the equivalent circuits. For example, when using a multilayer chip inductor manufactured by “ABC” corporation having the model No. “000,” values of the circuit constants for this component needs to be determined specifically. To do this, a variety of methods such as Newton's method and the like are known. For an example, a technique based on a global optimization algorithm is described below. First,

Z_test(fₙ)=ESR_test(fₙ)+jX_test(fₙ)

is taken to be an actual measured value of the impedance at a frequency fn of the particular subject component. Also,

Z_circuit(V,fₙ)=ESR_circuit(V,fₙ)+jX_circuit(V,fₙ)

is taken to be a circuit impedance at the frequency fn of a SPICE model for the component. Here, these V={V₁, V₂, . . . , Vₘ}, Vᵢ(i=1, 2, . . . , m) in the formula are circuit elements in the SPICE model.

An optimization mathematical model for extracting circuit constants is shown in the following Formula 1 or Formula 2. The target functions expressed by these formulas define relative errors between the measured value of impedance of the subject device and the value of impedance in the SPICE model, and these target functions represent the relative errors to be minimized. Formula 1 expresses the total error for the entire band region. Formula 2 expresses the maximum value of the error in the real component and the error in the imaginary component of the impendence at each frequency.

$$\begin{matrix} Min \{ \frac{{\sum }_{{f}_{n}} \vert Z\_circuit ( {V}_{1} , {V}_{2} , … , {V}_{m} , {f}_{n} ) - Z\_test ( {f}_{n} ) \vert}{{\sum }_{{f}_{n}} \vert Z\_test ( {f}_{n} )} \} & Formula 1 \\ Min \{ {Max}_{{f}_{n}} \{ \frac{\frac{\begin{matrix}\vert ESR\_circuit ( {V}_{1} , {V}_{2} , … , {V}_{m} , {f}_{n} \} - \\ ESR\_test ( {f}_{n} ) \vert\end{matrix}}{\begin{matrix}\vert ESR\_test ( {f}_{n} ) \vert \\ \vert X\_circuit ( {V}_{1} , {V}_{2} , … , {V}_{m} {f}_{n} ) - X\_test ( {f}_{n} ) \vert\end{matrix}}}{\vert X\_test ( {f}_{n} ) \vert} \} & Formula 2\end{matrix}$$

The procedure according to the above mentioned global optimization algorithm is shown as a flowchart in FIG. 3. First, as shown in FIG. 3, an initial region [V_{A}, V_{B}] of the circuit element is determined (step SA). The initial region [V_{A}, V_{B}] is made as large as possible so that a desired optimum solution is preferably included in the initial region [V_{A}, V_{B}]. Then, an optimum solution can be found by using the global optimization algorithm once, and the time required for simulation can be greatly decreased.

Next, the optimum solution V₀ (step SB) is found using the global optimization algorithm. Then, the above described Formula 1 and Formula 2 are used to find the error in the circuit impedance, and to determine whether or not the optimum solution V₀ is suitable (step SC). As a result of this, if the error between the actual measured value of the component and the circuit impedance of the SPICE model is excessively large that the above described optimum solution V₀ is determined to be inappropriate (N in step SC), then the optimum solution V₀ is used to reconstruct a new region [V_{A}, V_{B}] (step SD), and an optimum solution V₀ is again found using the global optimization algorithm (step SB).

The error between the circuit impedance according to the SPICE model and the actual measured value of the component represents the accuracy of the SPICE model. The relative error of this circuit impedance relative to the actual measured value is shown by the following Formula 3 and Formula 4. Among these formulas, Formula 3 expresses an ESR relative error, and Formula 4 expresses a reactance relative error.

$$\begin{matrix}δ ESR ( {f}_{n} ) = \{ \frac{\begin{matrix}\vert ESR\_circuit ( {V}_{1} , {V}_{2} , … , {V}_{m} , {f}_{n} \} - \\ ESR\_test ( {f}_{n} ) \vert\end{matrix}}{\vert ESR\_test ( {f}_{n} ) \vert} \} ( \% ) & Formula 3 \\ δ X ( {f}_{n} ) = \{ \frac{\begin{matrix}\vert X\_circuit ( {V}_{1} , {V}_{2} , … , {V}_{m} , {f}_{n} ) - \\ X\_test ( {f}_{n} ) \vert\end{matrix}}{\vert X\_test ( {f}_{n} ) \vert} \} ( \% ) & Formula 4\end{matrix}$$

The above processing is performed repeatedly, and when the relative error of the circuit impedance relative to the actually measured value reaches a “typical” value of, for example, less than or equal to 10%, a determination is made that a highly accurate SPICE model has been obtained (Y of step SC). This result is saved and the process ends (step SE).

Here, there are two reasons for making the typical value of the relative error less than or equal to 10%. First, because of the accuracy of a measuring device, measuring errors occur, and raw data of the actual measured value includes noise. Thus, a typical value of noise included in the raw date of the actual measured value for the multilayer chip inductor is about 10%. Second, because of variations in characteristics of each electronic component, the tolerance of the multilayer chip inductor is generally set as the J tolerance (±5%). Thus, if the typical value of the relative error is larger than 10%, the circuit accuracy is reduced. Therefore, it is preferable that the typical value of the relative error be less than or equal to 10%.

Next, the circuit constants of the equivalent circuit of the Embodiment were obtained using the above method, and were inputted into the SPICE simulator, and by performing simulations, the equivalent circuit model of the present invention was verified.

Next, examples of the numerical values obtained in the above-mentioned manner are described specifically.

(1) The case of a high frequency-use multilayer chip inductor manufactured by the present patent applicant “HK1005R10(100 nH)” (applicable range for the equivalent circuits of Embodiment 1 and Embodiment 2 is DC or frequency of less than or equal to 1.942 GHz).

a: The following results were obtained when numerical values for the circuit constants of respective elements were obtained by the above method using the basic equivalent circuit shown in FIG. 6(A) as the SPICE model.

### L0=100 nH,

### Rdc=0.894362Ω,

### Cp=0.268236 pF,

b: For the equivalent circuit of Embodiment 1 shown in FIG. 1(C), numerical values for the circuit constants of respective elements were obtained as follows.

### L0=55.712532 nH,

### Lm=48.885025 nH,

### L1=84.4907913 nH,

### R1=112.035797Ω,

### Cp=0.295752853 pF,

### Rp=3.24151635Ω,

### Ls=0.538956523 nH,

### Rdc1=0.796844184Ω,

### Rdc2=0.0975177884Ω.

c: For the equivalent circuit of Embodiment 2 shown in FIG. 1(C), numerical values for the circuit constants of respective elements were obtained as follows.

### L0=66.2275314 nH,

### Lm=45.4679871 nH,

### L1=77.8189621 nH,

### L2=108.25425 nH,

### R1=39.0474358Ω,

### R2=457.259155Ω,

### Cp=0.285327792 pF,

### Rp=2.12735748Ω,

### Ls=1.25335538 nH,

### Rdc1=0.663021684Ω,

### Rdc2=0.231340289Ω.

The SPICE files corresponding to these calculations are listed below. Comment lines were omitted.

a: The case of Embodiment 1:

.subckt HK1005R10_1 1 2
Ls 1 3 0.538956523n
L0 3 4 55.712532n
Lm 4 5 48.885025n
L1 4 7 84.4907913n
R1 7 5 112.035797
Cp 3 8 0.295752853p
Rp 8 6 3.24151635
Rdc1 5 6 0.796844184
Rdc2 6 2 0.0975177884
.ends

b: The case of Embodiment 2:

.subckt HK1005R10_2 1 2
Ls 1 3 1.25335538n
L0 3 4 66.2275314n
Lm 4 5 45.4679871n
L1 4 7 77.8189621n
R1 7 5 39.0474358
L2 4 8 108.25425n
R2 8 5 457.259155
Cp 3 9 0.285327792p
Rp 9 6 2.12735748
Rdc1 5 6 0.663021684
Rdc2 6 2 0.231340289
.ends

A program for calling the SPICE model as programmed is as follows. Comment lines were omitted.

a: The case of Embodiment 1:

Complex Function Z_R10_1(Freq)
COMPLEX ZHK1
Ls=0.538956523e−9
L0=55.712532e−9
Lm=48.885025e−9
L1=84.4907913e−9
R1=112.035797
Cp=0.295752853e−12
Rp=3.24151635
Rdc1=0.796844184
Rdc2=0.0975177884
Z_R10_1=ZHK1(Ls, L0, Lm, L1, R1, Cp, Rp, Rdc1, Rdc2, Freq)
Return
End

b: The case of Embodiment 2:

| Complex Function Z_R10_2(Freq) | |
|---|---|
| COMPLEX ZHK2 | |
| Ls=1.25335538e−9 | |
| L0=66.2275314e−9 | |
| Lm=45.4679871e−9 | |
| L1=77.8189621e−9 | |
| R1=39.0474358 | |
| L2=108.25425e−9 | |
| R2=457.259155 | |
| Cp=0.285327792e−12 | |
| Rp=2.12735748 | |
| Rdc1=0.663021684 | |
| Rdc2=0.231340289 | |
| Z_R10_2=ZHK2(Ls, L0, Lm, L1, R1, L2, R2, | |
| 1 | Cp, Rp, Rdc1, Rdc2, Freq) |

Return
End

Next, the results of calculations by the SPICE simulator using the circuit constants of the equivalent circuits of Embodiment 1 and Embodiment 2 obtained in the above described manner and the results of calculations by the SPICE simulator of the basic circuit shown in FIG. 6(A) are compared to the actual measured impedance values.

FIG. 4(A) is a graph showing the frequency dependence of the ESR (resistance component). As shown in FIG. 4(A), for Embodiment 1 and Embodiment 2, the results are very close to the actual measured values. In contrast, the graph of the basic circuit is very far apart from the actual measured values. Also, in comparing Embodiment 1 and Embodiment 2, it can be understood that Embodiment 2 has a very high accuracy. Similar results are obtained for the frequency dependence of the X (reactance) shown in FIG. 4(B). FIG. 4(C) shows the relative errors of ESR and X relative to the actual measured values for Embodiments 1, 2 and for the basic circuit. From these graphs, it can be understood that the equivalent circuits of Embodiment 1 and Embodiment 2 have very small errors when compared with the basic circuit. Similar comparisons were made for other multilayer chip inductors, and the simulation results very well matched with the actual measured values for the SPICE models of all the products. In addition, it was confirmed that Embodiment 2 has an even further improvement in accuracy than Embodiment 1.

### Embodiment 3

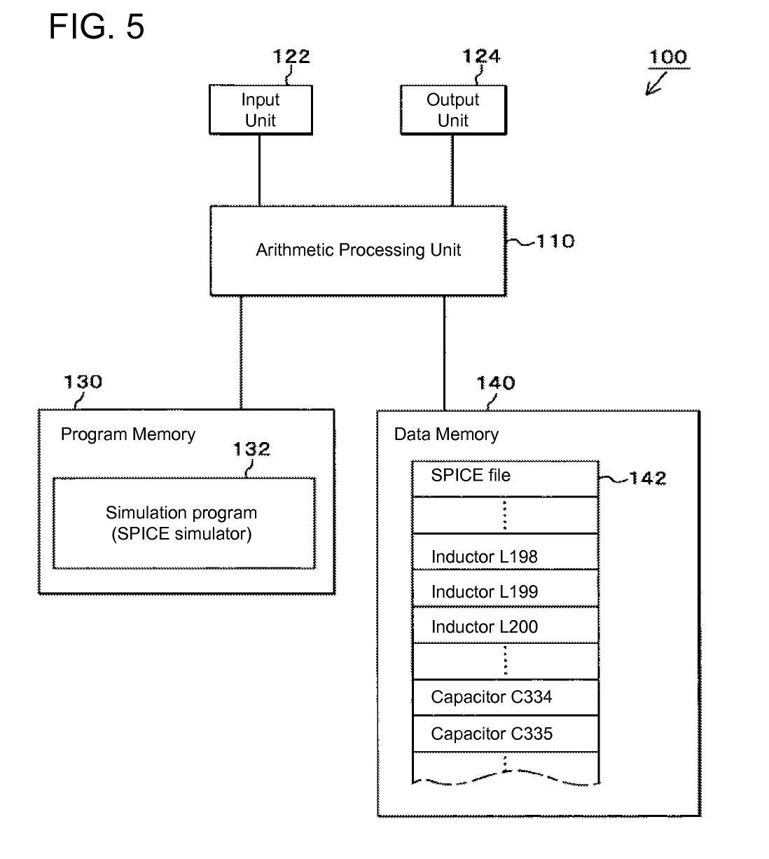

Next, referring to FIG. 5; an embodiment of a simulation apparatus is described. A simulation apparatus 100 of the present embodiment is made up of a general computer system, and is configured in such a way that an input unit 122, such as a keyboard or the like, an output unit 124, such as a liquid crystal display or the like, a program memory 130, and a data memory 140, are connected to an arithmetic processing unit 110, which is constructed by a CPU as the main component. A simulation program, for example, a SPICE simulator 132, is contained in the program memory 130. In the data memory 140, not only the SPICE file of the above-described multilayer chip inductor, but also SPICE files 142 of various types of other electronic components, such as capacitors, resistors or the like, are stored.

Based on input instructions from the input unit 122, the arithmetic processing unit 110 reads the SPICE files of the elements included in a circuit subject to simulation from the data memory 140, incorporates these files into the SPICE simulator 132, and performs arithmetic processing, such as simulation of circuit characteristics and the like. Using the SPICE file of the equivalent circuit for a multilayer chip inductor of the above described Embodiment 1 or Embodiment 2, very accurate simulation results can be obtained.

Effects such as the following can be obtained according to the embodiments of the present invention described above.

(1) An electronic component manufacturer or its representative trading company can provide the above-described SPICE model for a multilayer chip inductor to a customer, or publish the SPICE model on the company homepage for the convenience of customers in designing a circuit, who use the company's product.
(2) An electronic component manufacturer or its representative trading company can attempt to increase the sales channels for the products of the company, by making a SPICE file for, or by programming, the above-described SPICE model of a multilayer chip inductor component into a commercially available SPICE simulator, or alternatively, by publishing them on the company homepage so that customers can download them.
(3) By using the above-mentioned published SPICE model, an electronic device manufacturer or an electronic circuit design company can design an electronic product with high accuracy and can greatly reduce the design time. Also acceptance verification, device failure analysis, or the like can be performed.

Note that the present invention is not limited to the above described embodiments, and various modifications can be made within the scope that does not depart from the spirit of the present invention. For example, the following are also included.

(1) The numerical values for the equivalent circuit constants expressed in the above described embodiments are sample values, and different numerical values will result depending on components.
(2) The above described embodiments are examples in which the present invention is applied to the SPICE simulator. However, it does not prevent application of the present invention to various other types of simulators.
(3) Further, in the above described equivalent circuits, a resistance element having a very low resistance value, and an inductance element having a very low inductance value may be replaced by a short circuit. Also, a resistance element having a very high resistance value, and an inductance element having a very high inductance value may be replaced by an open circuit.

### INDUSTRIAL APPLICABILITY

Because the characteristics of a multilayer chip inductor are accurately expressed according to the present invention, the present invention is suited for simulation of various types of circuits that include a multilayer chip inductor.

### DESCRIPTION OF REFERENCE CHARACTERS

100 simulation apparatus
110 arithmetic processing unit
122 input unit
124 output unit
130 program memory
132 simulation program
140 data memory
142 SPICE file

1. A method for analyzing circuit constants of an equivalent circuit model for a multilayer chip inductor that includes a rectangular cuboid dielectric chip, internal conductors embedded within the chip and having terminals each being led out to a surface of the chip, and external electrodes formed on the surface of the chip so as to be electrically connected to the terminals of the internal conductors,
wherein the equivalent circuit model comprises:
a first series circuit in which an inductance L1 is connected in series to a resistance R1 for skin effect of the internal conductors;
a first parallel circuit in which Lm representing a mutual inductance between a direct current inductance L0 and the inductance L1 for electromagnetic proximity effect is connected to the first series circuit in parallel;
a second series circuit in which the inductance L0 is connected in series to one end of the first parallel circuit, and a direct current resistance Rdc1 of the internal conductors is connected in series to the other end of the first parallel circuit;
a third series circuit in which a parasitic capacitance Cp is connected in series to a resistance Rp representing a loss in a dielectric constituting the chip;
a second parallel circuit in which the third series circuit is connected in parallel to the second series circuit;
a parasitic inductance Ls of the external electrodes connected in series to one end of the second parallel circuit; and
a direct current resistance Rdc2 of the external electrodes connected in series to the other end of the second parallel circuit,
the method comprising:
determining numerical values of circuit constants included in the equivalent circuit model such that a typical value of relative error between an impedance value of the equivalent circuit model for the multilayer chip inductor and an actual measured value of an impedance of the multilayer chip inductor is minimized.

2. The method of analyzing circuit constants of an equivalent circuit model for a multilayer chip inductor according to claim 1, wherein a fourth series circuit in which an inductance L2 is connected in series to a resistance R2 for taking into account thickness of the internal conductors is further connected in parallel to the first parallel circuit of the equivalent circuit model.

3. The method of analyzing circuit constants of an equivalent circuit model for a multilayer chip inductor according to claim 1, wherein the numerical values of the circuit constants of the equivalent circuit are determined so that the typical value of the relative error is less than or equal to 10%.

4. A method of circuit simulation for performing a characteristics simulation of a circuit including a multilayer chip inductor, wherein the characteristics simulation of the circuit including the multilayer chip inductor is performed using the equivalent circuit model for the multilayer chip inductor in which the circuit constants have been determined by the method of analyzing circuit constants according to claim 3.
